(19) United States
(12) Patent Application Publication
(10) Pub. No.: US 2019/0286840 A1
(43) Pub. Date: Sep. 19, 2019

(54) CONTROLLING ACCESS TO CUSTOMER DATA BY EXTERNAL THIRD PARTIES

(71) Applicant: HONEYWELL INTERNATIONAL INC., Morris Plains, NJ (US)

(72) Inventors: ANDREW DUCA, PHOENIX, AZ (US); BENJAMIN EDWARD BLANCHETTE, DACULA, GA (US)

(21) Appl. No.: 15/922,318

(22) Filed: Mar. 15, 2018

(51) Int. Cl. G06F 21/62; G06F 21/60; H04L 29/06

(52) U.S. Cl. CPC G06F 21/6245; G06F 2221/2141; H04L 63/102; G06F 21/604

(57) ABSTRACT

A method for controlling access to cloud data includes a cloud computing system having a customer database including first and second customer data for a first and second customer. A management computer includes a processor having a memory device and digital logic, wherein memory device or digital logic is configured to implement a data access control process. The management computer transmits to the cloud computing system selections received from the first customer including a selected first and second third party user, a first data restriction for the first user, and a second data restriction for the second user. The first data restriction permits the first user access to a first data subset of the first customer data. In response to a data request from the first user, the first user is provided access to the first data subset.

### FIELD

This Disclosure relates to computers used with industrial hardware devices in an industrial process facility, and more specifically relates to controlling access to customer data by external third party users.

### BACKGROUND

Process facilities are used in various industries such as petroleum or chemical refining, pharmaceutical, ore refining pulp and paper, or other manufacturing operations. Processing facilities are often managed using process control systems. Processing facilities can include manufacturing plants, chemical plants, crude oil refineries, ore processing plants, and paper or pulp manufacturing plants. These industries typically use continuous processes and fluid processing. Process control systems typically manage the use of motors, valves, sensors, gauges and other industrial equipment in the processing facilities.

Process facilities use process control systems including various field devices to measure and sense process parameters. The field devices can include tank level gauges, temperature sensors, pressure sensors, chemical concentration sensors, valve controllers, actuators and other devices. A process facility can use tens or hundreds of field devices to monitor and actuators to control the process(es). The process control systems collect large amounts of data during operation that can be stored and used in optimization and planning for the process facility.

### SUMMARY

This summary is provided to introduce a brief selection of disclosed concepts in a simplified form that are further described below in the Detailed Description including the drawings provided. This Summary is not intended to limit the claimed subject matter's scope.

Disclosed embodiments recognize there is a problem when an industrial customer's site data resides in the cloud, third party individuals (those outside of the company) that may be considered experts for their particular products or systems used at the industrial customer's site are unable to view and thus analyze the company's data stored in the cloud. There is thus recognized to be significant untapped value in allowing third party ‘experts’ to view the company's data stored in the cloud that pertains to their particular products or systems, including enabling Original Equipment Manufacturer (OEM) individuals to monitor their specific equipment used at the plant and other assets, and to provide insight into their operation and maintenance. This also allows these otherwise unavailable equipment experts the data access needed to recommend changes in operating parameters for increased equipment performance or increased equipment lifetime or reliability.

Disclosed embodiments solve this problem by including a method for controlling access to cloud data. The method includes providing a cloud computing system having a customer database stored in cloud storage including first customer data for a first customer and at least second customer data for a second customer. A management computer includes a processor connected to a memory device that has digital logic. At least one of the data access control program and the digital logic is configured to implement a data access control process that causes the management computer to execute transmitting to the cloud computing system selections received from the first customer comprising a selected first third party user and a selected second third party user, a first data restriction for the third party user, and a second data restriction for the second third party user. The first data restriction only permits the first third party user access to a first data subset of the first customer data and the second data restriction only permits the second third party user access to a second data subset of the first customer data. The method further includes responsive to a data request from the first third party user, providing the first third party user access only to the first data subset.

### BRIEF DESCRIPTION OF THE DRAWINGS

FIG. 1 is a block diagram of an example system for controlling access to customer data by third party users, according to an example embodiment.

FIG. 2 is a block diagram of an example customer computer system, according to an example embodiment.

FIG. 3 is a block diagram of an example computer device, according to an example embodiment.

FIG. 4A is a block diagram of example contents of a management computer storage device, according to an example embodiment.

FIG. 4B is a block diagram of example contents of a cloud storage device, according to an example embodiment.

FIG. 5 is a diagrammatic view of restricted access to customer data by third party users, according to an example embodiment.

FIG. 6 is a flow chart that shows steps in an example method by which a customer controls and restricts access to customer data by third party users, according to an example embodiment.

FIG. 7 is a flow chart that shows steps in an example method of allowing third party user(s) access to customer data, according to an example embodiment.

FIG. 8 is a flow chart that shows steps in an example method of receiving recommended process changes or maintenance procedures from a third party user, according to an example embodiment.

### DETAILED DESCRIPTION

Disclosed embodiments are described with reference to the attached figures, wherein like reference numerals are used throughout the figures to designate similar or equivalent elements. The figures are not drawn to scale and they are provided merely to illustrate certain disclosed aspects. Several disclosed aspects are described below with reference to example applications for illustration. It should be understood that numerous specific details, relationships, and methods are set forth to provide a full understanding of the disclosed embodiments.

One having ordinary skill in the relevant art, however, will readily recognize that the subject matter disclosed herein can be practiced without one or more of the specific details or with other methods. In other instances, well-known structures or operations are not shown in detail to avoid obscuring certain aspects. This Disclosure is not limited by the illustrated ordering of acts or events, as some acts may occur in different orders and/or concurrently with other acts or events. Furthermore, not all illustrated acts or events are required to implement a methodology in accordance with the embodiments disclosed herein.

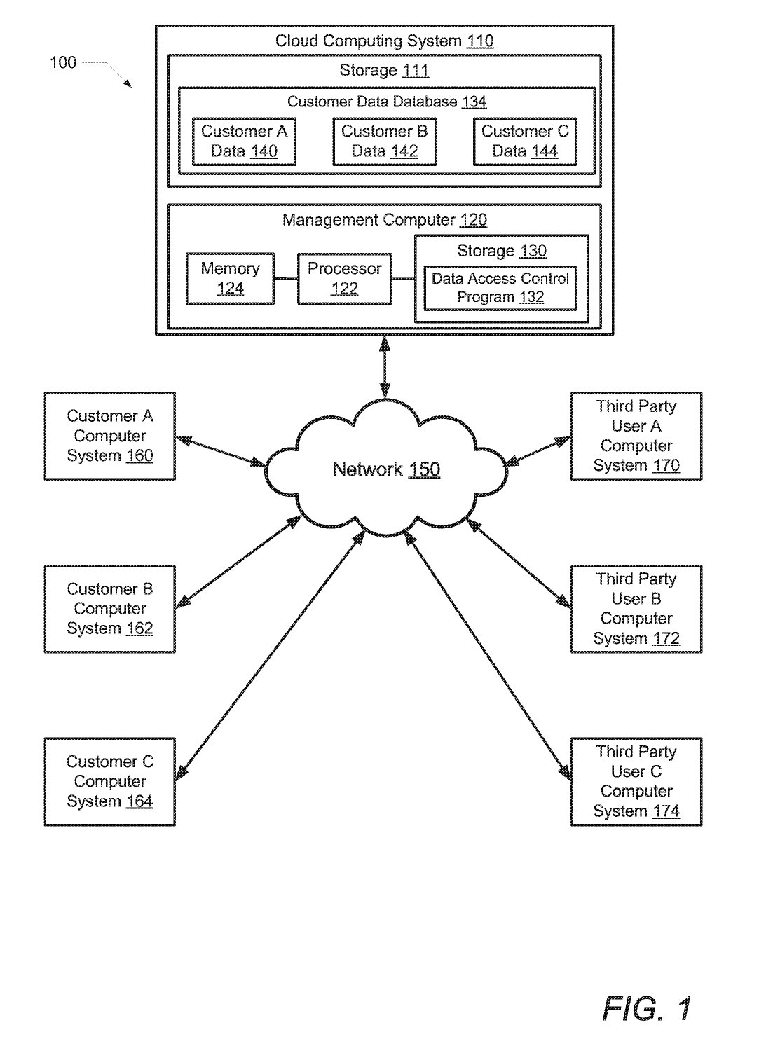

FIG. 1 illustrates a block diagram of an example system 100 for controlling access to customer data by external third party users. As shown in FIG. 1, system 100 comprises a cloud computing system 110 including data storage (storage) 111 that is in communication with several customer computer systems 160, 162, 164 and several third party user computer systems 170, 172 and 174 via a communication network 150. The communication network 150 can represent any suitable communications network or combination of networks. In one embodiment, the communication network 150 can be the Internet.

Cloud computing system 110 includes a management computer 120 that can manage and control access to data received from customer computer systems 160, 162 and 164. Management computer 120 includes a processor 122 (e.g., digital signal processor (DSP), microprocessor or microcontroller unit (MCU)) having an associated memory device or memory 124 and storage device or storage 130. Processor 122 can perform any one or more of the operations, applications, methods or methodologies described herein. Processor 122 running a data access control program or digital logic is needed to perform the data processing needed to implement disclosed data access control processes because a human cannot monitor, record and control access to data that is being continuously updated on the order of milliseconds as this is clearly too fast for a person to do.

Storage 111 can store various data such as customer data database 134. Customer data database 134 can include customer A data 140 received from customer A computer system 160, customer B data 142 received from customer B computer system 162 and customer C data 144 received from customer C computer system 164.

Storage 130 is shown storing a data access control program 132. Processor 122 implements the data access control program 132 which controls access to customer data (e.g., in customer data database 134) by third party users (e.g., third party user computer systems 170, 172 and 174). Although generally described herein as being software implemented, as known in the art, computer implemented processes such as a disclosed data access control program 132 may also be implemented by hardware including digital logic. Regarding hardware-based implementations, for example, equations can be converted into a digital logic gate pattern, such as using VHDL (a Hardware Description Language) that can then be realized using a programmable device such as a field-programmable gate array (FPGA) or a dedicated application-specific integrated circuit (ASIC) to implement the logic gate pattern.

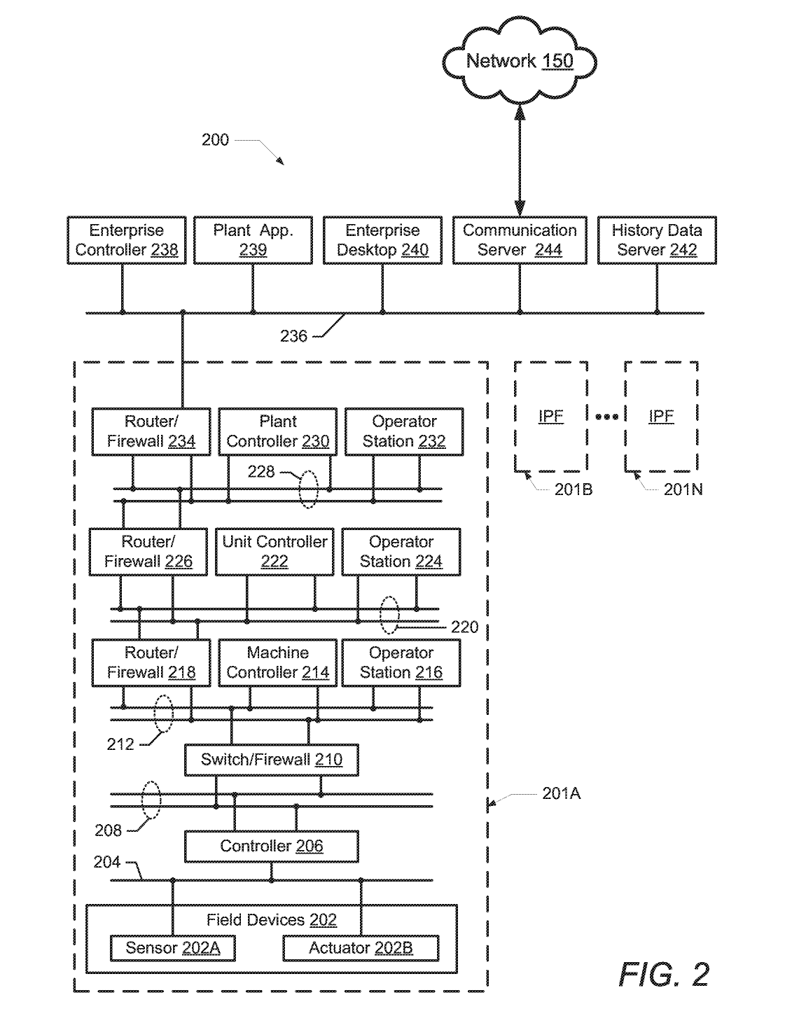

The customer computer systems include customer A computer system 160, customer B computer system 162, and customer C computer system 164. Each of the customers A, B and C can be a customer of the owner or an operator of the management computer 120. Each of the customer computer systems can be associated with an industrial process facility (IPF). See IPFs 201A, 201B-201N shown in FIG. 2 described below. These industries and facilities typically use continuous processes and fluid processing. The customer computing systems 160, 162 and 164 can receive data during the operation of their respective IPF and can transmit the collected data to management computer 120 and cloud computing system 110 via network 150. The data from customer computing systems 160, 162 and 164 can be stored to customer data database 134.

The third party user computer systems include third party user A computer system 170, third party user B computer system 172, and third party user C computer system 174. Although shown as third party user computer systems, the third party users can utilize other similar devices, including smartphones or tablets. Each of the third party user computer systems can be associated with one or more of the customers A, B, C, where the customers desire to grant or permit data access to one or more of the third party users A, B, C (170, 172, 174) to a portion of the data stored in customer data database 134.

Processor 122 implements the data access control program 132 which controls access to customer data by third party users. In one embodiment, processor 122 can receive customer data for customer A from customer A computer system 160. The customer data made available to third parties is a subset of the customer data 134 (i.e., customer A provides a third party user access to only customer A data 140). Processor 122 receives one or more data restrictions for the customer data in the customer data database 134 from the respective customer computer system 160, 162, 164. The data restriction permits access to the subset of customer data by one or more of the third party users. Processor 122 configures the customer data to allow access by one or more of the third party users based on the data restriction. Processor 122 allows one or more of the third party users to access the subset of the customer data.

When customer data is stored or resides in the storage 111 of the cloud computing system 110, as describe above there is recognized to be value in allowing experts external to or outside of the customer company, to view selected customer data in the customer data database 134. This is so that external third parties such as OEMs can monitor data regarding their specific equipment and assets at the customer location to enable providing insight into the operation and maintenance of the OEM equipment. Allowing access to customer data also allows process experts from external third parties the ability to improve the performance of operations located at customer sites.

A customer administrator can selectively provide access to certain cloud stored data types and values to other non-customer external third party users via management computer 120. After the external third party users have been specified and data restrictions have been established, the external third party user will generally only be able to access the data in the customer data database 134 that the customer administrator has allowed, permitted or assigned.

FIG. 2 illustrates an example block diagram of a customer computer system 200. In one embodiment, customer A computer system 160, customer B computer system 162 and customer C computer system 164 of FIG. 1 can have the same architecture and components of customer computer system 200. Customer computer system 200 can monitor, collect, store and transmit process data (such as real-time data from field devices such as sensors coupled to sense parameters (e.g., temperature or pressure) associated with processing equipment) from one or more plants or IPFs 201A, 201B-201N that are operated or associated with a customer. Each of IPF 201A-201N can be one or more of manufacturing plants, chemical plants, crude oil refineries, ore processing plants, and paper or pulp manufacturing plants. The IPFs can be a variety of manufacturing plants or storage locations that handle, process, store and transport a powder, liquid or fluid material. These industries and facilities typically use continuous processes and fluid processing. In general, each IPF can implement one or more processes and can individually or collectively be referred to as a process system. A process system generally represents any system or portion thereof configured to process one or more products or other materials in some manner.

Customer computing system 200 may include one or more field devices 202 including sensors 202A and actuators 202B. The sensors 202A and actuators 202B in a process system can perform a wide variety of functions. For example, sensors 202A can measure a wide variety of characteristics in the process system, such as temperature, pressure, or flow rate. Actuators 202B coupled to processing equipment (not shown) can alter a wide variety of characteristics in the process system. The sensors 202A and actuators 202B can represent any other or additional components in any suitable process system. Each of the sensors 202A includes any suitable structure for measuring one or more characteristics in a process system. Each of the actuators 202B includes any suitable structure for operating on or affecting one or more conditions in a process system.

At least one network 204 is coupled to the sensors 202A and actuators 202B. Network 204 facilitates the controller's 206 interaction with the sensors 202A and actuators 202B. The network 204 can transport measurement data from sensors 202A and provide control signals from the controller 206 to the actuators 202B. Network 204 can represent any suitable network or combination of networks. As particular examples, the network 204 could represent an Ethernet network, an electrical signal network (such as a hart or a foundation fieldbus network), a pneumatic control signal network, or any other or additional type(s) of network(s).

One or more controllers 206 are coupled to the network 204. Each controller 206 can use measurements from one or more sensors 202A to control the operation of one or more actuators 202B. For example, controller 206 can receive measurement data from sensors 202A and use the measurement data to generate control signals for actuators 202B. Each controller 206 includes any suitable structure for interacting with sensors 202A and controlling actuators 202B. Each controller 206 could, for example, represent a proportional-integral-derivative (PID) controller or a multivariable controller, such as a robust multivariable predictive control technology (RMPCT) controller or other type of controller implementing model predictive control (MPC) or other advanced predictive control (APC). As a particular example, each controller 206 could represent a computing device running a real-time operating system.

Two networks 208 are shown coupled to controllers 206. Networks 208 facilitate interaction with controllers 206, such as by transporting data to and from the controllers 206. Networks 208 could represent any suitable networks or combination of networks. As a particular example, the networks 208 could represent a redundant pair of Ethernet networks, such as a Fault Tolerant Ethernet (FTE) network from Honeywell Corporation. At least one switch/firewall 210 couples the networks 208 to two networks 212. The switch/firewall 210 may transport traffic from one network to another. The switch/firewall 210 may also block traffic on one network from reaching another network. The switch/firewall 210 includes any suitable structure for providing communication between networks, such as a Honeywell' control firewall (CF9) device. Networks 212 can represent any suitable networks, such as an FTE network.

One or more machine-level controllers 214 are coupled to networks 212. The machine-level controllers 214 perform various functions to support the operation and control of controllers 206, field devices 202, sensors 202A, and actuators 202B, which can be associated with a particular piece of industrial equipment (such as a distillation column, a boiler, or other machine). For example, the machine-level controllers 214 could log information collected or generated by controllers 206, such as measurement data from sensors 202A or control signals for actuators 202B. Machine-level controllers 214 can also execute applications that control the operation of controllers 206, thereby controlling the operation of actuators 202B. Machine-level controllers 214 can also provide secure access to controllers 206. Each of the machine-level controllers 214 includes any suitable structure for providing access to, control of, or operations related to a machine or other individual piece of equipment. Each of the machine-level controllers 214 could, for example, represent a server computing device running a Windows operating system. Although not shown, different machine-level controllers 214 can be used to control different pieces of equipment in a process system (where each piece of equipment is associated with one or more controllers 206, sensors 202A and actuators 202B).

One or more operator stations 216 are coupled to networks 212. Operator stations 216 represent computing or communication devices providing user access to machine-level controllers 214, which could then provide user access to the controllers 206 (and possibly the sensors 202A and actuators 202B). As particular examples, operator stations 216 can allow users to review the operational history of sensors 202A and actuators 202B using information collected by controllers 206 and/or machine-level controllers 214. The operator stations 216 can also allow users to adjust the operation of the sensors 202A, actuators 202B, controllers 206, or machine-level controllers 214. In addition, the operator stations 216 can receive and display warnings, alerts, or other messages or displays generated by controllers 206 or machine-level controllers 214. Each of the operator stations 216 includes any suitable structure for supporting user access and control of one or more components in the customer computer system 200. Each of the operator stations 216 could, for example, represent a computing device running a Windows operating system. At least one router/firewall 218 couples networks 212 to two networks 220. Router/firewall 218 includes any suitable structure for providing communication between networks, such as a secure router or combination router/firewall. Networks 220 can represent any suitable networks, such as an FTE network.

One or more unit-level controllers 222 are coupled to networks 220. Each unit-level controller 222 can be associated with a unit in a process system, which represents a collection of different machines operating together to implement at least part of a process. The unit-level controllers 222 perform various functions to support the operation and control of components in the lower levels. For example, the unit-level controllers 222 could log information collected or generated by the components in the lower levels, execute applications that control the components in the lower levels, and provide secure access to the components in the lower levels. Each of the unit-level controllers 222 includes any suitable structure for providing access to, control of, or operations related to one or more machines or other pieces of equipment in a process unit. Each of the unit-level controllers 222 could, for example, represent a server computing device running a Windows operating system. Although not shown, different unit-level controllers 222 could be used to control different units in a process system (where each unit is associated with one or more machine-level controllers 214, controllers 206, sensors 202A and actuators 202B).

Access to the unit-level controllers 222 may be provided by one or more operator stations 224. Each of the operator stations 224 includes any suitable structure for supporting user access and control of one or more components in the customer computer system 200. Each of the operator stations 224 could, for example, represent a computing device running a Windows operating system. At least one router/firewall 226 couples the networks 220 to two networks 228. The router/firewall 226 includes any suitable structure for providing communication between networks, such as a secure router or combination router/firewall. The networks 228 could represent any suitable networks, such as an FTE network.

One or more plant or IPF level controllers 230 are coupled to networks 228. Each plant level controller 230 is typically associated with one of the plants or IPFs 201A-201N, which can include one or more process units that implement the same, similar, or different processes. The plant level controllers 230 perform various functions to support the operation and control of components in the lower levels. As particular examples, the plant level controller 230 could execute one or more manufacturing execution system (MES) applications, scheduling applications, or other or additional plant or process control applications. Each of the plant level controllers 230 includes any suitable structure for providing access to, control of, or operations related to one or more process units in a process plant. Each of the plant level controllers 230 could, for example, represent a server computing device running a Windows operating system.

Access to the plant level controllers 230 can be provided by one or more operator stations 232. Each of the operator stations 232 includes any suitable structure for supporting user access and control of one or more components in the customer computing system 200. Each of the operator stations 232 could, for example, represent a computing device running a Windows operating system. At least one router/firewall 234 couples the networks 228 to one or more networks 236. Router/firewall 234 includes any suitable structure for providing communication between networks, such as a secure router or combination router/firewall. The network 236 could represent any suitable network, such as an enterprise-wide Ethernet or other network or all or a portion of a larger network (such as the Internet).

One or more enterprise level controllers 238 are coupled to network 236. Each enterprise level controller 238 is typically able to perform planning operations for multiple IPFs 201A-201N and to control various aspects of IPFs 201A-201N. The enterprise level controllers 238 can also perform various functions to support the operation and control of components in IPFs 201A-201N. As particular examples, the enterprise level controller 238 could execute one or more order processing applications, enterprise resource planning (ERP) applications, advanced planning and scheduling (APS) applications, or any other or additional enterprise control applications. Each of the enterprise level controllers 238 includes any suitable structure for providing access to, control of, or operations related to the control of one or more plants or IPFs. Each of the enterprise level controllers 238 could, for example, represent a server computing device running a Windows operating system. In this document, the term “enterprise” refers to an organization having one or more plants, IPFs or other processing facilities to be managed.

Various plant applications 239 can be executed in customer computer system 200. In this example, plant applications 239 are shown as residing on customer computer system 100, although plant applications 239 could reside on other computers. The plant applications 239 can represent any suitable applications that are executed by server computers or other computing devices. Access to the enterprise level controllers 238 and plant applications 239 may be provided by one or more enterprise desktops (also referred to as operator stations) 240. Each of the enterprise desktops 240 includes any suitable structure for supporting user access and control of one or more components in customer computer system 200. Each of the enterprise desktops 240 could, for example, represent a computing device running a Windows operating system.

FIG. 2 can include other components, such as one or more databases. The database(s) associated with each level could store any suitable information associated with that level or one or more other levels of the customer computer system 200. For example, a history data server 242 can be coupled to network 236. History data server 242 can represent a component that stores various information and databases about customer computer system 200. History data server 242 can store received process information and data from IPFs 201A-201N including data from field devices 202. History data server 242 can store received process information and data and information used during production scheduling and optimization. History data server 242 represents any suitable structure for storing and facilitating retrieval of information such as a storage server. Although shown as a single centralized component coupled to network 236, History data server 242 could be located elsewhere in customer computer system 200.

In particular embodiments, the various controllers and operator stations in FIG. 2 can represent computing devices. For example, each of the controllers 206, 214, 222, 230, 238 and each of the operator stations 216, 224, 232, 240 could include one or more processing devices and one or more memories for storing instructions and data used, generated, or collected by the processing device(s). Each of the controllers 206, 214, 222, 230, 238 and each of the operator stations 216, 224, 232, 240 could also include at least one network interface, such as one or more Ethernet interfaces or wireless transceivers, facilitating communication over one or more networks or communication paths.

Customer computer system 200 further includes a communication server 244. A Communication server 244 is communicatively coupled to network 150. Communication server 244 can receive data from other components of customer computer system 200 and transmit the data to network 150. Communication server 244 can receive data from network 150 and transmit the data to other components of customer computer system 200. For example, communication server 244 can receive information identifying different events and historical data that occur within customer computer system 200. Communication server 244 can represent a server computing device.

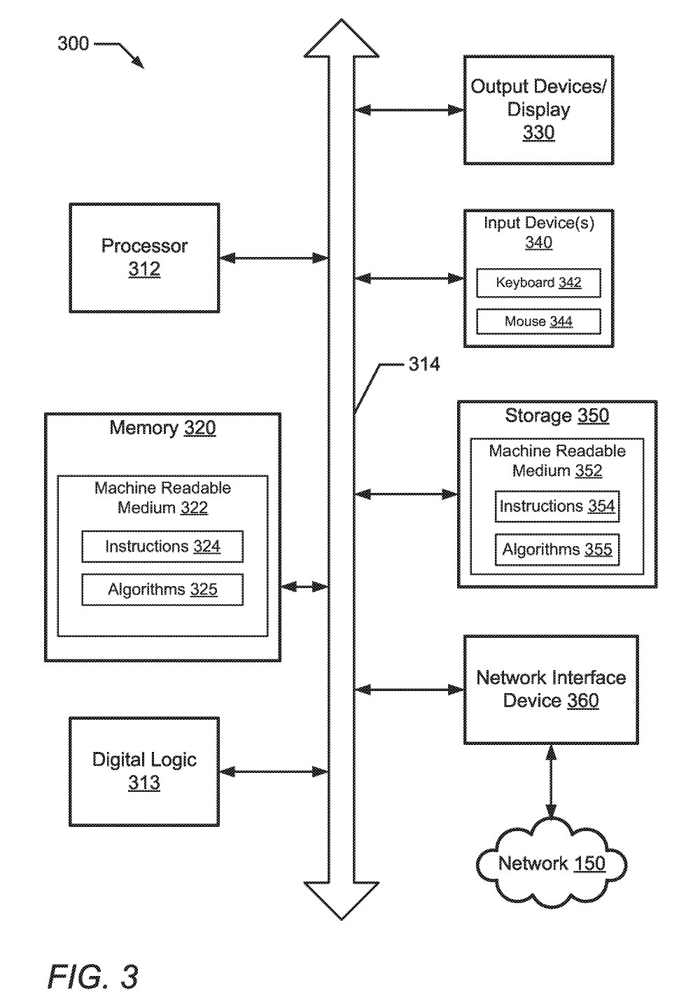

FIG. 3 illustrates an example block diagram of a computer device 300 that can be used to control access to customer data stored in a customer data database by third party users. Computer device 300 can have the same components and architecture as the previously described computers, controllers, operator stations and servers of FIGS. 1 and 2. Computer device 300 can represent the management computer 120, customer A computer system 160, customer B computer system 162, customer C computer system 164, third party user A computer system 170, third party user B computer system 172 and third party user C computer system 174, all shown in FIG. 1. Computer device 300 can further represent each of controllers 206, 214, 222, 230, 238, each of operator stations 216, 224, 232, 240, history server 242, and communication server 244.

Computer device 300 includes one or more processors 312 such as a central processing unit (CPU) and a storage device such as memory 320, which communicate with each other via system bus 314 which can represent a data bus and an address bus. Memory 320 includes a machine readable medium 322 on which is generally stored one or more sets of software such as instructions 324 and/or algorithms 325 embodying any one or more of the data access control program methodologies or functions described herein. Memory 320 can store instructions 324 and/or algorithms 325 for execution by processor 312. Computer device 300 further includes output devices/display 330 such as a video screen that is connected to system bus 314. Computer device 300 also has input devices 340 such as an alphanumeric input device (e.g., keyboard 342) and a cursor control device (e.g., a mouse 344) that are connected to system bus 314. Computer device 300 further includes digital logic 313. Digital logic 313 can be a programmable device such as a FPGA or a dedicated ASIC that can implement a logic gate pattern.

A storage device 350, such as a hard drive or solid state drive, is connected to and in communication with the system bus 314. The storage device 350 includes a machine readable medium 352 on which is stored one or more sets of software such as instructions 354 and/or algorithms 355 embodying any one or more of the methodologies or functions described herein. The instructions 354 and/or algorithms 355 can also reside, completely or at least partially, within the memory 320 and/or within the processor 312 during execution thereof. The memory 320 and the processor 312 can also contain machine readable media.

While the machine readable medium 322 and 352 are shown in an example embodiment to be a single medium, the term “machine readable medium” should be taken to include a single medium or multiple media (e.g., a centralized or distributed database, and/or associated caches and servers) that store the one or more sets of instructions. The term “machine readable medium” shall also be taken to include any medium that is capable of storing, encoding or carrying a set of instructions for execution by the computer system and that cause the computer system to perform any one or more of the methodologies shown in the various embodiments of the present invention. The term “machine readable medium” shall accordingly be taken to include, but not be limited to, solid-state memories, optical and magnetic media, and carrier wave signals. Computer device 300 further includes a network interface device 360 that is connected to system bus 314. Network interface device 360 is coupled to communication network 150.

Although FIG. 3 illustrates one example of a computer device 300 that enables controlling access to customer data by third party users, various changes can be made to FIG. 3 without impacting its function. For example, components could be added, omitted, combined, further subdivided, or placed in any other suitable configuration according to particular needs. Computer devices can come in a wide variety of configurations, and FIG. 3 does not limit this disclosure to any particular configuration of computer devices.

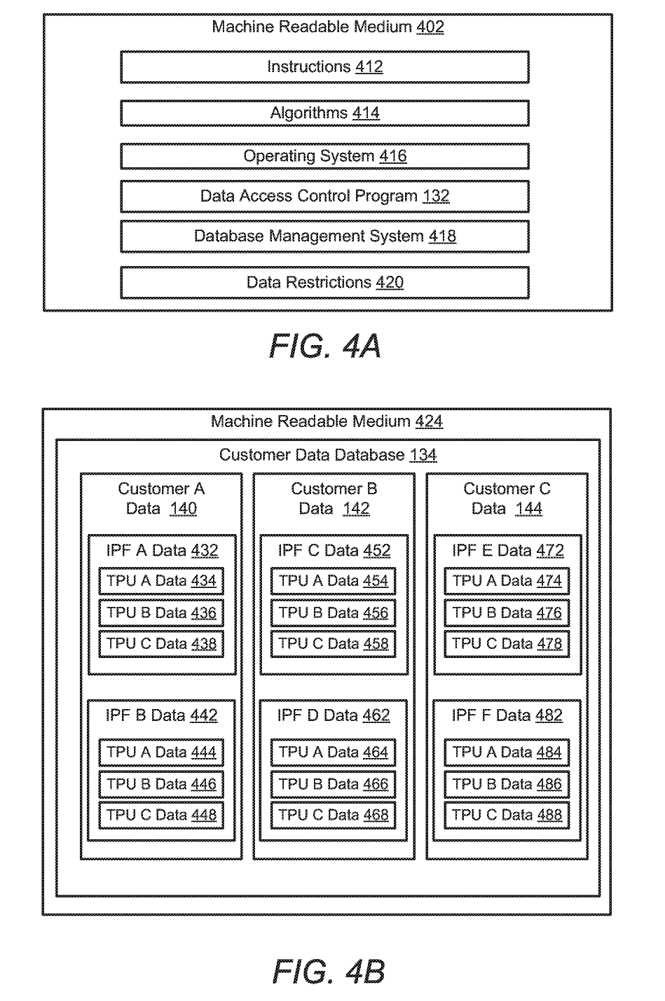

FIG. 4A illustrates example contents that are stored in storage device or storage 130 shown as a machine readable medium 402. Storage 130 includes instructions 412, algorithms 414, operating system 416 and data access control program 132. Instructions 412 and/or algorithms 414 can enable one or more of the methodologies or functions described herein. Operating system 416 is system software that manages computer hardware and software resources of management computer 120 and provides common services for computer programs. Data access control program 132, when executed by processor 122, can control access to customer data (e.g., customer data database 134) by third party users (e.g., third party user computer systems 170, 172 and 174 shown in FIG. 1 described above).

Storage 130 further includes a database management system (DBMS) 418 that includes an integrated set of computer software that allows users to interact with one or more databases and provides access to the data contained in the database. In one embodiment, data access control program 132 can interact with DBMS 418 to restrict or limit access to particular data within customer data database 134. The DBMS 418 provides various functions that allow entry, storage and retrieval of large quantities of information and provides ways to manage how that information is organized.

Storage 130 further includes data restrictions 420. Data restrictions 420 contain data restriction types and properties that permit/allow and control access to customer data within customer data database 134. Data restrictions 420 contain information received from customers 160-164 about which data is allowed to be accessed by third party users 170-174, and how the data is permitted to be accessed.

FIG. 4B illustrates example contents that are stored in the storage 111 of a cloud computing system 110 shown as a machine readable medium 424 storing customer data database 134. Customer data database 134 is a structured set of customer data received from customer computer systems 160, 162, 164 that is accessible in various ways. In an embodiment, customer data database 134 can be accessed using DBMS 418.

Customer data database 134 further includes stored customer A data 140 that is received from customer A computer system 160. Customer A data 140 contains process and operation data related IPF A data 432 and IPF B data 442. IPF A data 432 and IPF B data 442 can be data associated with the operation of separate IPFs. IPF A data 432 includes third party user (TPU). A data 434 associated with a third party user A, third party user B data 436 associated with a third party user B and third party user C data 438 associated with a third party user C. IPF B data 442 includes third party user A data 444 associated with a third party user A, third party user B data 446 associated with a third party user B and third party user C data 448 associated with a third party user C.

Customer data database 134 includes stored customer B data 142 that is received from customer B computer system 162. Customer B data 142 contains process and operation related IPF C data 452 and IPF D data 462. IPF C data 452 and IPF D data 462 can be data associated with the operation of separate IPFs. IPF C data 452 includes third party user A data 454 associated with a third party user A, third party user B data 456 associated with a third party user B and third party user C data 458 associated with a third party user C. IPF D data 462 includes third party user A data 464 associated with a third party user A, third party user B data 466 associated with a third party user B and third party user C data 468 associated with a third party user C.

Customer data database 134 further includes stored customer C data 144 that is received from customer C computer system 164. Customer C data 144 contains process and operation related IPF E data 472 and IPF F data 482. IPF E data 472 and IPF F data 482 can be data associated with the operation of separate IPFs. IPF E data 472 includes third party user A data 474 associated with a third party user A, third party user B data 476 associated with a third party user B and third party user C data 478 associated with a third party user C. IPF F data 482 includes third party user A data 484 associated with a third party user A, third party user B data 486 associated with a third party user B and third party user C data 488 associated with a third party user C.

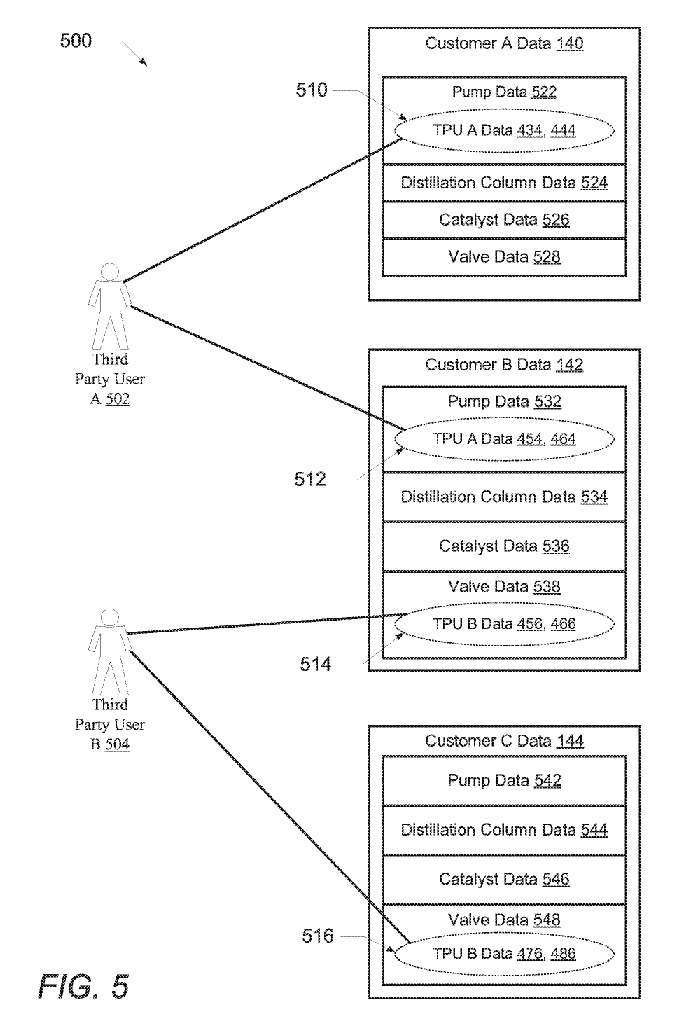

FIG. 5 illustrates a system model diagram 500 of restricted access to customer data by third party users. In FIG. 5, third party user A 502 is shown having access to or being allowed to access a subset 510 of customer A data 140 and a subset 512 of customer B data 142. Third party user B 504 is shown having access to or being allowed to access a subset 514 of customer B data 142 and a subset 516 of customer C data 144.

Customer A data 140 can include pump data 522, distillation column data 524, catalyst data 526 and valve data 528. Pump data 522 can include operating data about pumps operating within IPFs of customer A such as maintenance, motor speeds, pressure, temperatures and flow rate data. Distillation column data 524 can include operating data about distillation columns operating within IPFs of customer A such as maintenance, chemical concentrations, pressure, temperature and flow rate data. Catalyst data 526 can include operating data about catalysts operating within IPFs of customer A such as maintenance, chemical concentrations, pressure, temperature and flow rate data. Valve data 528 can include operating data about valves operating within IPFs of customer A such as maintenance, valve settings, valve openings and closings and flow rate data. Pump data 522 includes a subset 510 that contains third party user A data 434 and 444. In one embodiment, third party user A 502 can be a pump manufacturer and subset 510 can contain all the data from customer A associated with pumps manufactured by third party user A 502.

Customer B data 142 can include pump data 532, distillation column data 534, catalyst data 536 and valve data 538. Pump data 532 can include operating data about pumps operating within IPFs of customer B such as maintenance, motor speeds, pressure, temperatures and flow rate data. Distillation column data 534 can include operating data about distillation columns operating within IPFs of customer B such as maintenance, chemical concentrations, pressure, temperature and flow rate data. Catalyst data 536 can include operating data about catalysts operating within IPFs of customer B such as maintenance, chemical concentrations, pressure, temperature and flow rate data. Valve data 538 can include operating data about valves operating within IPFs of customer A such as maintenance, valve settings, valve openings and closings and flow rate data. Pump data 532 includes a subset 512 that contains third party user A data 454 and 464. In one embodiment, third party user A 502 can be a pump manufacturer and subset 512 can contain all the data from customer B associated with pumps manufactured by third party user A 502. Valve data 538 includes a subset 514 that contains third party user B data 456 and 466. In one embodiment, third party user B 504 can be a valve manufacturer and subset 514 can contain all the data from customer B associated with valves manufactured by third party user B 504.

Customer C data 144 can include pump data 542, distillation column data 544, catalyst data 546 and valve data 548. Pump data 542 can include operating data about pumps operating within IPFs of customer C such as maintenance, motor speeds, pressure, temperatures and flow rate data. Distillation column data 544 can include operating data about distillation columns operating within IPFs of customer C such as maintenance, chemical concentrations, pressure, temperature and flow rate data. Catalyst data 546 can include operating data about catalysts operating within IPFs of customer C such as maintenance, chemical concentrations, pressure, temperature and flow rate data. Valve data 548 can include operating data about valves operating within IPFs of customer C such as maintenance, valve settings, valve openings and closings and flow rate data. Valve data 548 includes a subset 516 that contains third party user B data 476 and 486. In one embodiment, third party user B 504 can be a valve manufacturer and subset 516 can contain all the data from customer C associated with valves manufactured by third party user B 504.

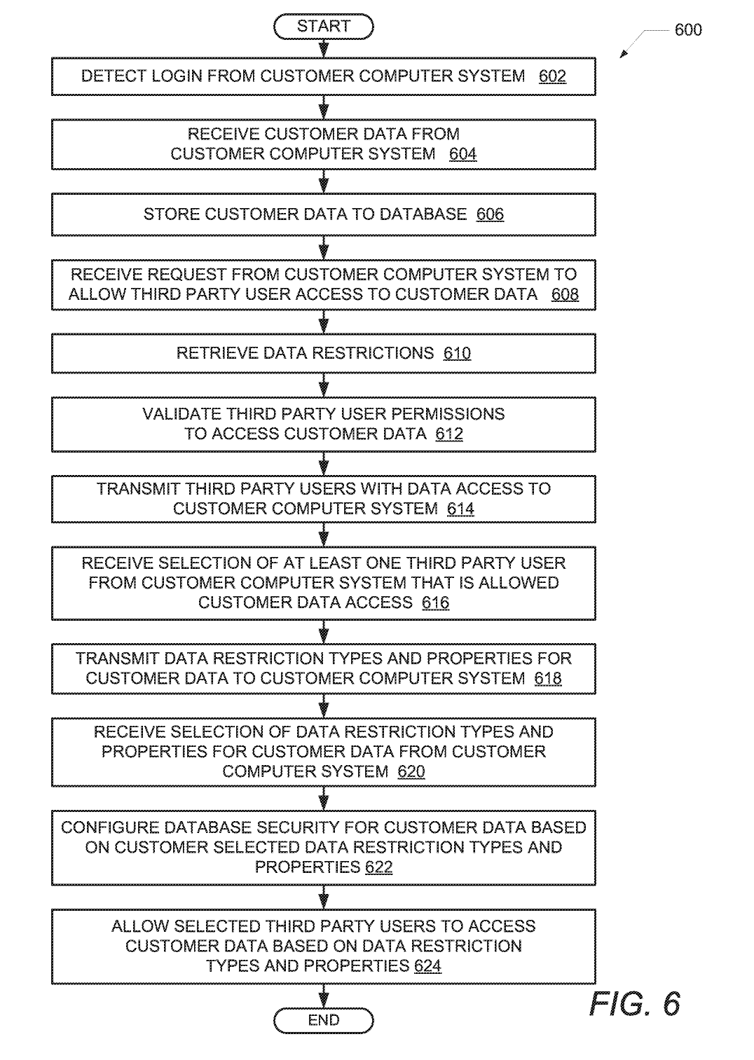

FIG. 6 is a flow chart showing steps in an example method 600 that enables a customer to control and restrict access to customer data stored in cloud computing system 110. With additional reference to FIGS. 1-5, method 600 can be implemented via the execution of instructions 412 and/or algorithms 414 by processor 122 within management computer 120 and specifically by the execution of data access control program 132 by processor 122.

Method 600 begins at the start block and proceeds to block 602. At block 602, processor 122 detects that a login from one or more customer computer systems 160, 162 and 164 to management computer 120 has occurred. At block 604, processor 122 receives customer A data 140 from customer A computer system 160, if logged in. Processor 122 receives customer B data 142 from customer B computer system 162, if logged in. Processor 122 receives customer C data 144 from customer C computer system 164, if logged in. The remaining description of method 600 assumes that customer A 160 has logged in, and that customer A data 140 has been received. Customer A data 140 includes a subset 510 of customer A data 140 that is associated with third party user A 502. Processor 122 stores the received customer A data 140 to customer data database 134 (block 606).

Processor 122 receives a request from customer A computer system 160 to allow third party access to customer A data 140 (block 608). Processor 122 retrieves data restrictions 420 (block 610) and determines the third party users that have permitted access to customer data (block 612). Processor 122 transmits the third party users that have permitted access to customer data (block 614) and receives a selection of at least one third party user (e.g., third party user A 502) that is allowed access to customer data (block 616). Processor 122 transmits the data restrictions properties and types for customer data from data restrictions 420 to customer A computer system 160 (block 618). Processor 122 receives a selection from customer A computer system 160 of the data restrictions properties and types for third party user(s) that are allowed access to customer data (block 620) and stores the received data restrictions properties and types for third party user(s) to data restrictions 420 (block 622). The data restriction properties and types define permitted access to one or more subsets of customer A customer data by third party user (s).

Processor 122 configures the security of customer A data 140 to allow access by third party (e.g., third party user A 502) based on the customer selected data restriction properties and types stored in data restrictions 420 (block 624). Processor 122 allows the selected third party users party (e.g., third party user A 502) to access a subset (e.g. subset 510) of customer A data 140 based on the data restriction properties and types selected by customer A via customer A computer system 160 (block 626). Method 600 then ends.

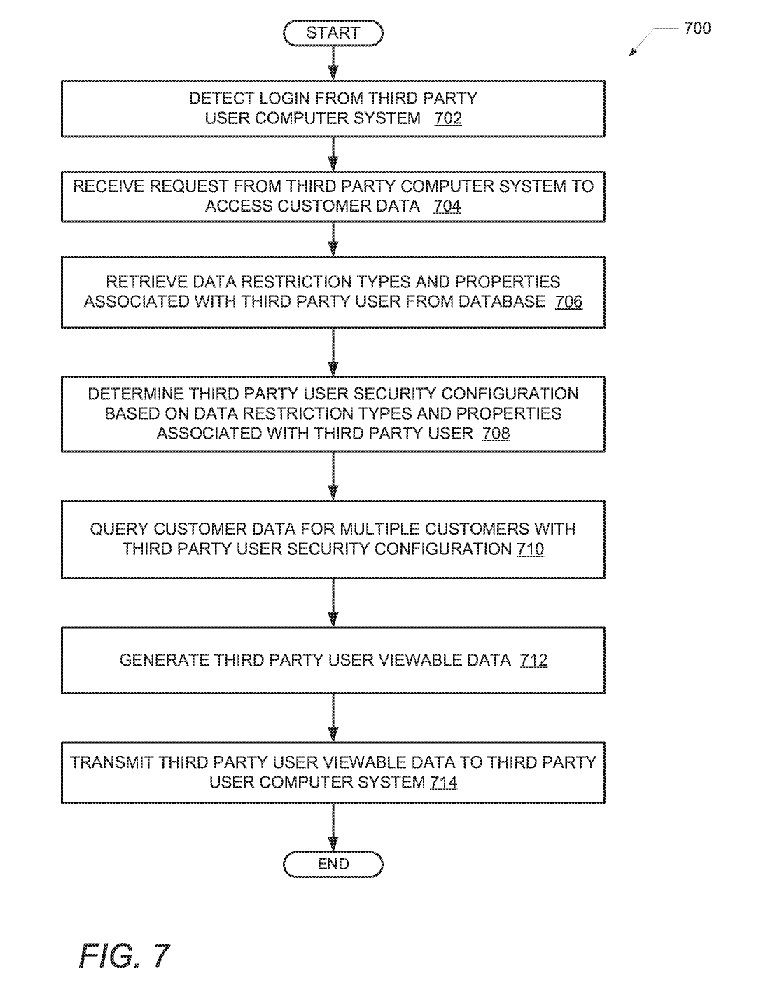

FIG. 7 is a flow chart showing steps in an example method 700 that enables a third party user to access specific customer data stored in storage 111 of a cloud computing system 110. With additional reference to FIGS. 1-5, method 700 can be implemented via the execution of instructions 412 and/or algorithms 414 by processor 122 within management computer 120 and specifically by the execution of data access control program 132 by processor 122.

Method 700 begins at the start block and proceeds to block 702. At block 702, processor 122 detects that a login from one or more third party user computer systems 170, 172 and 174 to management computer 120 has occurred. Processor 122 receives a request from one or more of the third party users 170, 172 and 174 to access customer data stored in customer database 134 (block 704). Processor 122 retrieves data restrictions 420 from storage 130 (block 706). Data restrictions 420 contain the data restriction types and properties for accessing customer data for each third party user that have been provided by customers via customer computer systems.

Processor 122 determines a security configuration for each of the third party users based on the data restriction types and properties stored in data restrictions 420 (block 708). Processor 122 queries customer data database 134 using the security configuration for each of the third party users (block 710). In one embodiment, processor 122 can query customer A data 140, customer B data 142 and customer C data 144 at least partially using DBMS 418 and the determined security configurations.

Processor 122 generates third party user viewable data from the query results (block 712). For example, processor 122 can generate subsets 510, 512, 514 and 516 as third party user viewable data. At block 714, processor 122 transmits the third party user viewable data (i.e., one or more of subsets 510, 512, 514 and 516) from management computer 120 to each of the respective third party user computer systems (i.e., one or more of third party user A computer system 170, third party user B computer system 172 and third party user C computer system 174 that have been allowed to access customer data. Method 700 then ends.

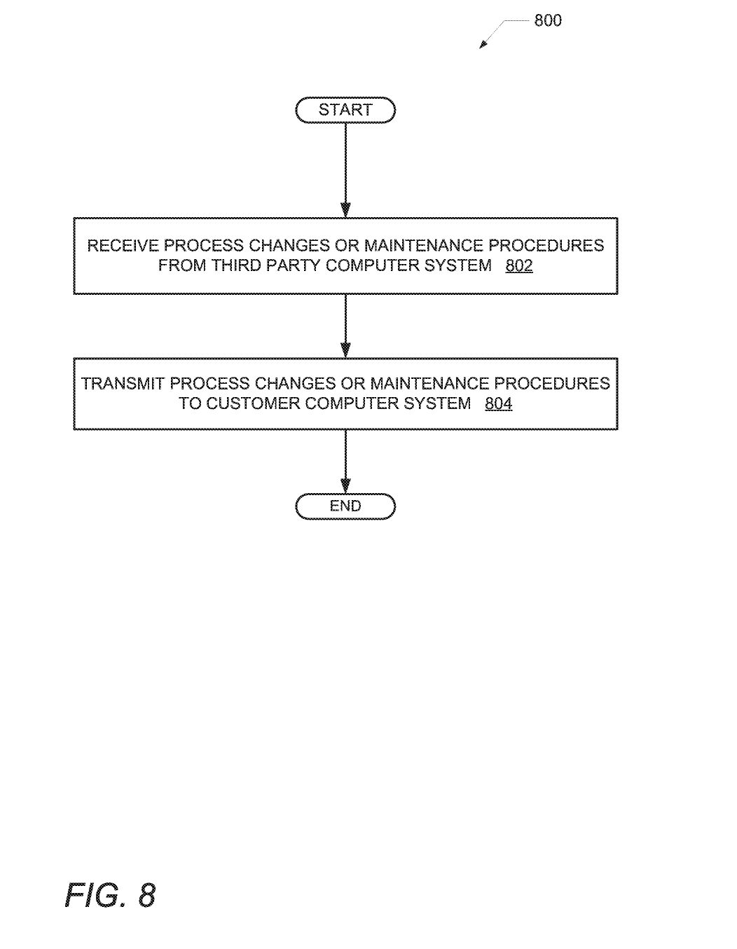

FIG. 8 is a flow chart that shows steps in an example method 800 of receiving recommended process changes or maintenance procedures from third parties. With additional reference to FIGS. 1-5, method 800 can be implemented via the execution of instructions 412 and/or algorithms 414 by processor 122 within management computer 120 and specifically by the execution of data access control program 132 by processor 122.

Method 800 begins at the start block and proceeds to block 802. At block 802, processor 122 receives at least one recommended process change or maintenance procedure from at least one third party user (e.g., third party user A 502) via third party user A computer system 170. The recommended process changes or maintenance procedures are based on analysis by the third party user of one or more data subsets (e.g., data subset 510). For example, the maintenance procedure could be that bearings are recommended to be replaced in a pump. Processor 122 transmits the recommended process changes or maintenance procedures to the customer computer system associated with the data subset (e.g. customer A computer system 160) (block 804). Method 800 then ends.

In one embodiment, this Disclosure can benefit a third party user (e.g., third party user A 502) in that by having access to real world process data for their equipment or processes from a larger number of customers, the third party user can combine data or information they have from multiple customers to perform additional analytics. The additional analytics can be used to refine algorithms to detect equipment or process issues, or improve the performance of third party equipment or processes.

While various disclosed embodiments have been described above, it should be understood that they have been presented by way of example only, and not limitation. Numerous changes to the subject matter disclosed herein can be made in accordance with this Disclosure without departing from the spirit or scope of this Disclosure. In addition, while a particular feature may have been disclosed with respect to only one of several implementations, such feature may be combined with one or more other features of the other implementations as may be desired and advantageous for any given or particular application.

1. A method for controlling access to cloud data, comprising:
providing a cloud computing system having a customer database including first customer data for a first customer and second customer data for a second customer stored in cloud storage, and a management computer including a processor connected to a memory device and digital logic, wherein at least one of said processor and said digital logic is configured to implement a data access control process to cause said management computer to execute:
transmitting to said cloud computing system selections received from said first customer comprising a selected first third party user and a selected second third party user, a first data restriction for said first third party user, and a second data restriction for said second third party user, said first data restriction only permitting said first third party user access to a first data subset of said first customer data and said second data restriction only permitting said second third party user access to a second data subset of said first customer data; and
responsive to a data request from said first third party user, providing said first third party user access only to said first data subset.

2. The method of claim 1, wherein said management computer further executes:
responsive to a data request from said second third party user, providing said second third party user access only to said second data subset.

3. The method of claim 1, wherein said management computer further executes:
responsive to said data request from said first third party user, determining if a third data restriction permits access by said first third party user to said first data subset and said second data subset; and
responsive to determining that said third data restriction permits access by said first third party user to said first data subset and said second data subset, providing said first third party user access to said first data subset and said second data subset.

4. The method of claim 1, wherein said first customer data includes industrial process facility data about at least one industrial process facility that is received from a plurality of field devices in said at least one industrial process facility.

5. The method of claim 1, wherein said management computer further executes:
transmitting a plurality of third party users to said first customer via a first customer computer system;
receiving a selection of at least one of said third party users to access said first customer data from said first customer computer system; and
transmitting a plurality of data restriction types and properties to said first customer via said first customer computer system.

6. The method of claim 1, wherein said management computer further executes:
responsive to receiving said data request from said first third party user to access said first customer data;
retrieving said first customer data restriction for said first customer data;
determining a first security configuration for said first third party user based on said first customer data restriction;
querying said first customer data using said first security configuration;
generating said first data subset based on said querying of said first customer data using said first security configuration; and
transmitting said first data subset to said first third party user.

7. The method of claim 1, wherein said management computer further executes:
receiving at least one recommended process change or maintenance procedure from said first third party user, said recommended process change or maintenance procedure based on analysis by said first third party user of said first data subset.

8. A system for controlling access to cloud data, comprising:
a cloud computing system having a customer database including first customer data for a first customer and second customer data for a second customer stored in cloud storage;
a management computer including a processor connected to a memory device and digital logic, wherein at least one of said processor and said digital logic implements a data access control process to cause said management computer to:
transmit to said cloud computing system selections received from said first customer comprising a selected first third party user and a selected second third party user, a first data restriction for said first third party user, and a second data restriction for said second third party user, said first data restriction only permitting said first third party user access to a first data subset of said first customer data and said second data restriction only permitting said second third party user access to a second data subset of said first customer data; and
responsive to a data request from said first third party user, provide said first third party user access only to said first data subset.

9. The system of claim 8, wherein said data access control process further causes said management computer to:
responsive to a data request from said second third party user, provide said second third party user access only to said second data subset.

10. The system of claim 8, wherein said data access control process further causes said management computer to:
responsive to said data request from said first third party user, determine if a third data restriction permits access by said first third party user to said first data subset and said second data subset; and
responsive to determining that said third data restriction permits access by said first third party user to said first data subset and said second data subset, provide said first third party user access to said first data subset and said second data subset.

11. The system of claim 8, wherein said first customer data includes industrial process facility data about at least one industrial process facility that is received from a plurality of field devices in said at least one industrial process facility.

12. The system of claim 8, wherein said data access control process further causes said management computer to:
transmit a plurality of third party users to said first customer via a first customer computer system;
receive a selection of at least one of said third party users to access said first customer data from said first customer computer system; and
transmit a plurality of data restriction types and properties to said first customer via said first customer computer system.

13. The system of claim 8, wherein said data access control process further causes said management computer to:
responsive to receiving said data request from said first third party user to access said first customer data;
retrieve said first customer data restriction for said first customer data;
determine a first security configuration for said first third party user based on said first customer data restriction;
query said first customer data using said first security configuration;
generate said first data subset based on said querying of said first customer data using said first security configuration; and
transmit said first data subset to said first third party user.

14. The system of claim 8, wherein said data access control process further causes said management computer to:
receive at least one recommended process change or maintenance procedure from said first third party user, said at least one recommended process change or maintenance procedure based on analysis by said first third party user of said first data subset.

15. A computer program product, comprising:
a non-transitory data storage medium that includes program instructions executable by a processor to enable at least said processor to execute a method of controlling access to cloud data, said computer program product comprising:
code for transmitting to a cloud computing system selections received from a first customer comprising a selected first third party user and a selected second third party user, a first data restriction for said first third party user, and a second data restriction for said second third party user, said first data restriction only permitting said first third party user access to a first data subset of a first customer data stored in cloud storage and said second data restriction only permitting said second third party user access to a second data subset of said first customer data stored in cloud storage, and
responsive to a data request from said first third party user, code for providing said first third party user access only to said first data subset.

16. The computer program product of claim 15, wherein said computer program product further comprises:
responsive to a data request from said second third party user, code for providing said second third party user access only to said second data subset.

17. The computer program product of claim 15, wherein said computer program product further comprises:
responsive to said data request from said first third party user, code for determining if a third data restriction permits access by said first third party user to said first data subset and said second data subset; and
responsive to determining that said third data restriction permits access by said first third party user to said first data subset and said second data subset, said code for providing said first third party user access to said first data subset and said second data subset.

18. The computer program product of claim 15, wherein said first customer data includes industrial process facility data about at least one industrial process facility that is received from a plurality of field devices in said at least one industrial process facility.

19. The computer program product of claim 15, wherein said computer program product further comprises:
code for transmitting a plurality of third party users to said first customer via a first customer computer system;
code for receiving a selection of at least one of said third party users to access said first customer data from said first customer computer system; and
code for transmitting a plurality of data restriction types and properties to said first customer via said first customer computer system.

20. The computer program product of claim 15, wherein said computer program product further comprises:
code for receiving at least one recommended process change or maintenance procedure from said first third party user, said at least one recommended process change or maintenance procedure based on analysis by said first third party user of said first data subset.
